(19) United States
(12) Patent Application Publication
(10) Pub. No.: US 2009/0238494 A1
(43) Pub. Date: Sep. 24, 2009

(54) SYSTEM FOR CHARACTER RECOGNITION

(75) Inventors: Toshihiro Ochi, Kawasaki (JP); Shigeru Hidesawa, Kawasaki (JP); Haruyo Iguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/407,054

(22) Filed: Mar. 19, 2009

(30) Foreign Application Priority Data
Mar. 21, 2008 (JP) 2008-074276

(51) Int. Cl. G06K 9/20

(52) U.S. Cl. 382/317; 345/156

(57) ABSTRACT

A system for character recognition from a sheet bearing a plurality of characters, has a base for supporting the sheet, an image input device for taking an image of each of the characters on the sheet, a handle for supporting and manipulating the image input device, an axis, a sphere part, a receiving part fixed to the base and having a hollow for accommodating the sphere part, one of the sphere part and the hollow having a plurality of depressions and the other having a projection for fitting into one of the depressions, whereby when a view angle of the image input device is changed to point a location of each of characters on the sheet by manipulation of the handle, the image input device is rotated about the axis and a character recognizing unit for recognizing the character on the image taken by the image input device.

### CROSS-REFERENCE TO RELATED APPLICATION

This application is based upon and claims the benefit of priority of the prior Japanese Patent Application No. 2008-074276, filed on Mar. 21, 2008, the entire contents of which are incorporated herein by reference.

### FIELD

A certain aspect of the embodiments discussed herein is related to a system for character recognition.

### BACKGROUND

The present art relates to a system for character recognition that inputs character to a personal computer, for example.

Personal computers have been widely spread, and text is generally created by using a personal computer.

Hitherto, a character input system with a keyboard, a mouse and a remote control device according to the mouse is applied for inputting characters to a personal computer (refer to Japanese Laid-open Patent Publication No. 2005-78251 and Japanese Laid-open Patent Publication No. 10-49623, for example.) A character input system with voice input has come to use for inputting characters by voice by reading desired characters aloud by a user.

Elderly or handicapped people are not familiar with operations on personal computers to use a keyboard requiring operations on multiple keys thereon. The character input system with the mouse and/or remote control device allows input of characters by placing a cursor on a monitor to a desired character among strings displayed on the monitor. Elderly people or users as described above may easily input characters incorrectly due to the excessive high degree of freedom of the movement of the mouse, for example. The character input system with voice input requires complicated preparations including the registration of a characteristic of his/her voice before inputting characters.

A character input system which is easy also for elderly or handicapped users to use has been demanded with the situations as described as a background.

### SUMMARY

According to an aspect of an embodiment, a system for character recognition from a sheet bearing a plurality of characters has a base for supporting the sheet, an image input device for taking an image of each of the characters on the sheet, a handle for supporting and manipulating the image input device, an axis fixed to the handle at one end thereof, a sphere part, fixed to the axis at the other end of the axis, a receiving part fixed to the base and having a hollow for accommodating the sphere part, one of the sphere part and the hollow having a plurality of depressions and the other of the sphere part having a projection for fitting into one of the depressions, whereby when a view angle of the image input device is changed to point a location of each of characters on the sheet by manipulation of the handle, the image input device is rotated about the axis and a character recognizing unit for recognizing the character on the image taken by the image input device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing a specific embodiment of a first basic form of the character input system;

FIGS. 2A and 2B are schematic diagrams showing a structure of the supporting mechanism shown in FIG. 1;

FIG. 3 is an enlarged diagram of the area C in FIG. 2A;

FIG. 4 is an enlarged diagram showing characters and cross-shape marks on the character sheet in FIG. 1;

FIGS. 5A and 5B are diagrams conceptually showing the search for a cross-shape mark;

FIG. 6 is a diagram showing how a cross-shape mark is searched and how a recognition area is defined;

FIG. 7 is a diagram conceptually showing the emphasis of a character to be performed before pattern recognition;

FIG. 8 is a flowchart showing a flow of character input processing;

FIG. 9 is a diagram showing another character sheet example, which is different from the character sheet shown in FIG. 1;

FIG. 10 is a diagram showing an example of the character sheet on which characters are hand-written; and

FIG. 11 is a diagram showing a specific embodiment of a second basic form of the character input system.

### DESCRIPTION OF EMBODIMENTS

With reference to drawings, specific embodiments of the character input system described above according to the first and second basic forms will be described below.

First of all, a specific embodiment of the first basic form of the character input system will be described.

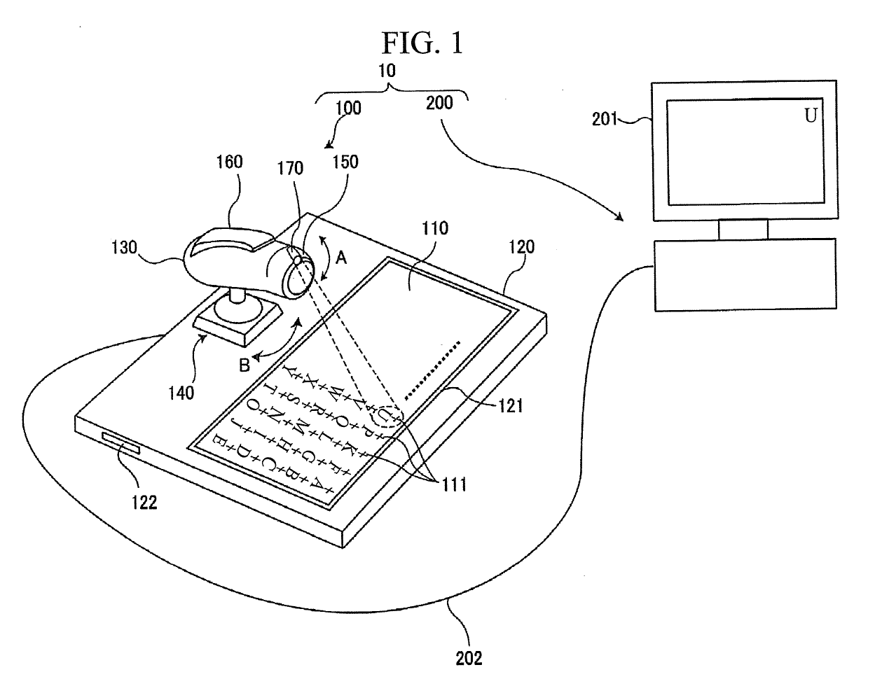

FIG. 1 is a diagram showing a specific embodiment of the first basic form of the character input system.

A character input system 1 shown in FIG. 1 includes a character input apparatus 100 that photographs a desired character of multiple characters arranged on a character sheet, which will be described later, and a personal computer 200 that recognizes a character in the photographed image by pattern recognition. In this embodiment, the personal computer 200 also functions as a personal computer to which a character is inputted by the character input system 10. The character input apparatus 100 corresponds to an example of the character input apparatus in the first basic form of the character input system, and the personal computer 200 corresponds to an example of the character recognizing apparatus in the basic form. The sheet bears a plurality of characters.

As the character sheet in the character input apparatus 100, a character sheet is used on which a maximum of 55 characters are arranged in an arrangement of 5 rows by 11 columns. Then, the character input apparatus 100 includes a base 120 having a sheet tray 121 on which the character sheet is to be placed. The base 120 corresponds to an example of the base in the first basic form of the character input system.

FIG. 1 shows a character sheet 110 on which alphabets from “A” to “Z” printed in black are arranged as described above. The character sheet 110 corresponds to an example of the sheet in the first basic form of the character input system. Besides the alphabets, 29 characters such as numbers etc. are printed on the character sheet 110.

In the character input system 10, a control handle 130 to be grasped by a user by one hand is supported on the base 120 rotatably in five steps at predetermined intervals in the first direction indicated by the shown arrow A, which is orthogonal to the base 120, and rotatably in 11 steps at predetermined intervals in the second direction indicated by the shown arrow B. In this embodiment, the control handle 130 is supported on the base 120 as described above through a supporting mechanism 140, which will be described below. The combination of the control handle 130 and the supporting mechanism 140 corresponds to an example of the controller in the first basic form of the character input system.

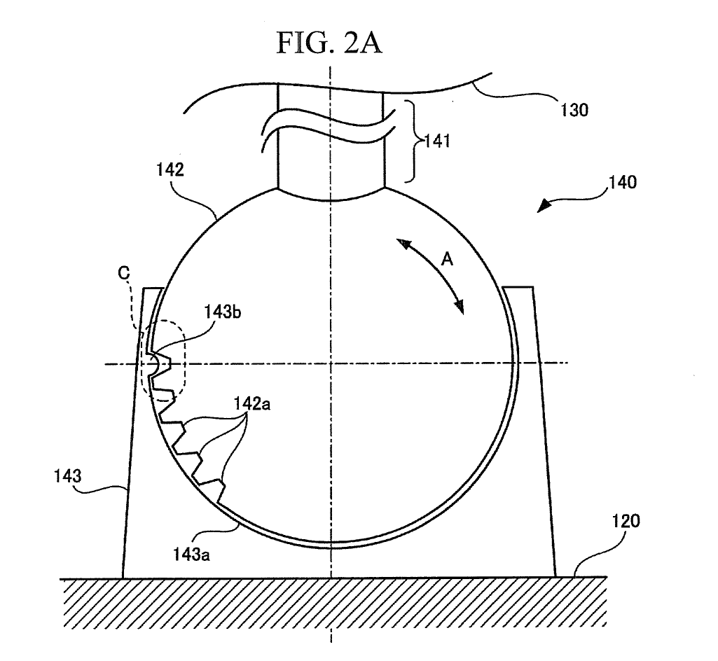

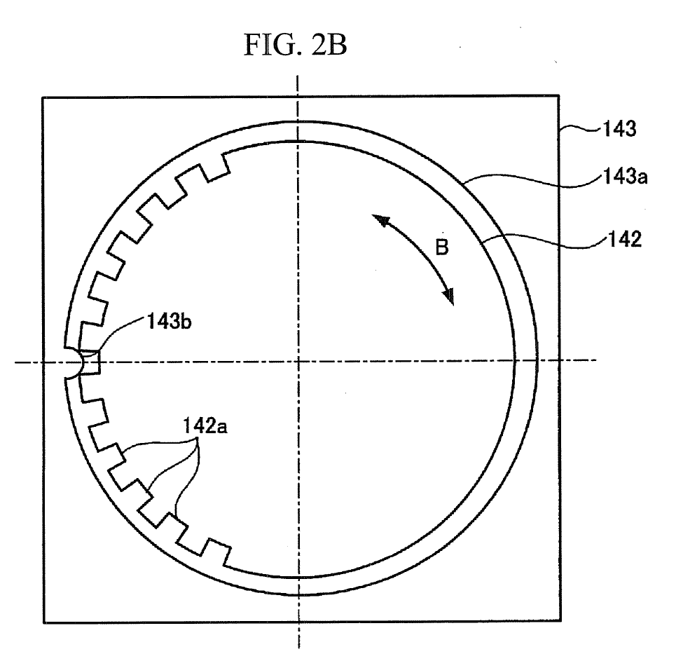

FIGS. 2A and 2B are schematic diagrams showing a structure of the supporting mechanism shown in FIG. 1.

FIG. 2A shows a section of the supporting mechanism 140, which is orthogonal to the base 120. FIG. 2B shows a section of the supporting mechanism 140, which is in parallel with the base 120. In FIGS. 2A and 2B, the right side corresponds to the sheet tray 121 side in FIG. 1 of the base 120.

The supporting mechanism 140 shown in FIGS. 2A and 2B includes an axis part 141 with one of both ends fixed to the control handle 130, a sphere part 142 fixed to the other end of the axis part 141 and a receiving part 143 having a hollow 143a to accommodate the sphere part 142. The sphere part 142 is fitted into the hollow 143a of the receiving part 143.

The sphere part 142 has 55 depressions 142a in a part of ¼ of the surface of the sphere part 142 on the opposite side of the sheet tray 121, which is close to the base 120 side, in FIG. 1. The receiving part 143 has a projection 143b to fit into an arbitrary one of the 55 projections 142a on the internal surface of the hollow 143a.

The 55 depressions 142a are provided in an arrangement of 5 rows by 11 columns at equal intervals on the surface of the sphere part 142. Here, the row direction in the arrangement corresponds to the vertical direction in FIG. 2A and the direction of depth in FIG. 2B. The column direction corresponds to the direction of depth in FIG. 2A and the vertical direction in FIG. 2B. FIG. 2A shows an arrangement of 5 rows of the depressions 142a, and FIG. 2B shows an arrangement of 11 columns of the depressions 142a.

The attitude of the sphere part 142 is stable when the projection 143b of the receiving part 143 fits into one of 55 depressions 142a. A small gap is provided between the sphere part 142 and the hollow 143a of the receiving part 143. If a certain amount of force is applied to the sphere part 142, the depression 142a currently holding the projection 143b comes off the projection 143b, and the projection 143b fits into the adjacent depression 142a. In other words, in this embodiment, a click is formed by the depression 142a of the sphere part 142 and the projection 143b of the receiving part 143. This structure allows the sphere part 142 to rotate in five steps at predetermined intervals in the first direction indicated by the arrow A in FIG. 2A, which corresponds to the row direction of the arrangement of the depressions 142a, and to rotate in 11 steps at predetermined intervals in the second direction indicated by the arrow B shown in FIG. 2B, which corresponds to the column direction. Because the control handle 130 connects to the sphere part 142 through the axis part 141, the supporting mechanism 140 supports the control handle 130 on the base 120 rotatably in five steps in the first direction and rotatably in 11 steps in the second direction. As a result, the control handle 130 can freely take 55 attitudes depending on the combinations of the rotations in 5 steps in the first direction and the rotations in 11 steps in the second direction. A view angle of a digital camera 150 is changed to point a location of each of characters on the sheet by manipulation of the handle, and the digital camera 150 is rotated about the axis part 141. When the view angle of the digital camera 150 is changed, the projection travels along with the depression to cause the axis to rotate so as to correct the rotation angle of the digital camera 150 with respect to each of the characters.

In this embodiment, the surface of the projection 143b and the internal surfaces of the depressions 142a are covered by conductors which will be described below.

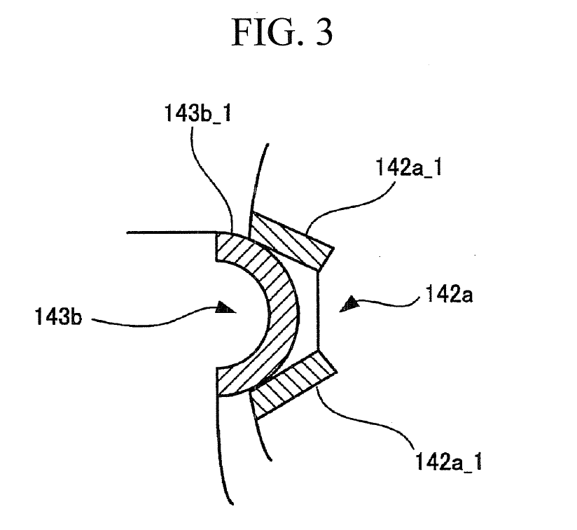

FIG. 3 is an enlarged diagram of the area C in FIG. 2A.

As shown in FIG. 3, the surface of the projection 143b is covered by a conductor 143b_1, and the inner surfaces of the depressions 142a are covered by two conductors 142a_1, which are electrically isolated. If the projection 143b fits into one of the depressions 142a, the two conductors 142a_1 on the depression 142a side are brought into conduction through the conductor 143b_1 on the projection 143b side. If the control handle 130 is rotating and the projection 143b does not fit into any of the depressions 142a, the two conductors 142a_1 on the depression 142a side are brought out of conduction. In this embodiment, by monitoring the conduction state between the two conductors 142a_1 on each of the depressions 142a, whether the control handle 130 has one of the 55 attitudes or is rotating and not taking any attitude or not is determined. The determination on the attitude of the control handle 130 will be described again later.

Ending the description on the supporting mechanism 140 above, the character input system 10 will be continuously described with reference back to FIG. 1 again.

In this embodiment, a digital camera 150 for photographing a character on the character sheet 110 is mounted on the end on the sheet tray 121 side of the control handle 130 supported by the base 120 through the supporting mechanism 140. A photograph switch 160 to be operated by a user for instructing the digital camera 150 to photograph is mounted on the trunk part of the control handle 130. In this case, the digital camera 150 corresponds to an example of the camera in the first basic form of the character input system, and the photograph switch 160 corresponds to an example of the switch in the basic form.

As described above, the control handle 130 can take 55 attitudes depending on the combinations of the rotations in five steps in the first direction indicated by the arrow A and the rotations in 11 steps in the second direction indicated by the arrow B. As a result, the digital camera 150 can photograph 55 subject positions within the sheet tray 121, which correspond to the 55 attitudes of the control handle 130.

In this case, the arrangement positions of the characters on the character sheet 110 placed on the sheet tray 121 corresponds to the positions where the characters can be placed at the 55 subject positions when the character sheet 110 is placed on the sheet tray 121. As a result, the attitudes of the control handle 130 correspond to the characters arranged on the character sheet 110 on the one-to-one basis, and the digital camera 150 can capture the character corresponding to the attitude of the character handle 130 in the angle of field.

In this embodiment, the photographing by the digital camera 150 is implemented if two conditions are satisfied that the control handle 130 is taking one of the 55 attitudes and that the photograph switch 160 is being pushed. Whether the former condition is satisfied or not is determined by monitoring the conduction state of the two conductors 142a_1 on the 55 depressions 142 of the sphere part 142 in FIGS. 2A and 2B, as described with reference to FIG. 3. More specifically, if the conduction is recognized at one of the 55 depressions 142, the satisfaction of the condition that the control handle 130 is taking one of the 55 attitudes is determined. If conduction is recognized at none of the depressions 142, it is determined that the condition is not satisfied. In this way, the photographing by the digital camera 150 is implemented under the condition that a character is securely captured by the angle of field of the digital camera 150.

A light 170 is mounted on the control handle 130. The light 170 illuminates the character corresponding to the attitude of the control handle 130 at the subject position corresponding to the attitude of the control handle 130, that is, on the character sheet 110. The illumination by the light 170 allows a user to visually recognize which character is currently being captured by the angle of field of the digital camera 150. The digital camera is an image input device for taking an image of each of the characters on the sheet. The control handle 130 supports and manipulates the image input device. In this embodiment, the colors of illumination by the light 170 differ between the time when the digital camera 150 captures a character simply by the angle of field and the time when the photograph switch is pushed to cause the digital camera 150 to photograph a character. Thus, a user can recognize that the character desired by him/her is being photographed.

In this embodiment, a user basically moves the control handle 130 to illuminate a desired character to capture the character within the angle of field of the digital camera 150 and then pushes the photograph switch 160 to photograph it. The basic operation is performed to photograph one character each time. In this embodiment however, for example, in order to photograph desired serial multiple characters in the row direction or column direction, the control handle 130 may be moved to illuminate the first character of the series, and the control handle 130 may be moved to illuminate a character sequentially along the series by keeping the control switch 160 pushed. This operation automatically photographs because the two conditions are satisfied every time a character is captured by the angle of field when the control handle 130 is moved by keeping the photograph switch 160 pushed, which allows more effective photographing than the photographing each one character by pushing the photograph switch 160. In this case, the color of the illumination of the light 170 stays the color indicating that photographing is being performed.

In the character input system 10 in FIG. 1, pattern recognition is performed in the personal computer 200 on the photographed image obtained by the photographing as described above by the digital camera 150 to recognize the character on the photographed image. The personal computer 200 includes a monitor 201, and the recognized character is displayed on the monitor 201.

In this embodiment, the base 120 has a power switch 122 for powering on/off components of the character input apparatus 100 and further acts as an interface for exchanging information with the personal computer 200. The personal computer 200 is connected to the base 120 via a connection cable 202. The photographed image for each character obtained by photographing by the digital camera 150 is transmitted to the personal computer 200 through the base 120 and via the connection cable 202 and is made available for the character recognition. Here in this embodiment, a cross-shape mark 111 is provided above each character on the character sheet 110 in order to increase the accuracy of the character recognition. The cross-shape mark 111 corresponds to an example of the reference mark, which is a reference for the position of a character on an image for the character recognition.

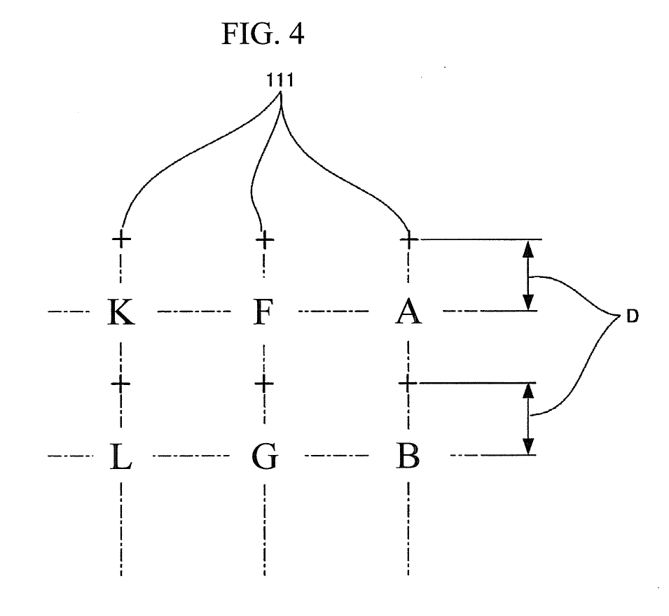

FIG. 4 is an enlarged diagram showing characters and cross-shape marks on the character sheet in FIG. 1.

As shown in FIG. 4, the cross-shape marks 111 are placed at positions above and away from the characters by a predetermined distance D, fitting into the angle of field of the digital camera 150 along with the characters. In this embodiment, the recognition of a character on a photographed image by the personal computer 200 includes first searching the cross-shape mark 111, which is common in form to all characters, and then performing pattern recognition on the character within a predetermined recognition area about the cross-shape mark 111.

The character recognition using the character mark 111 will be described below.

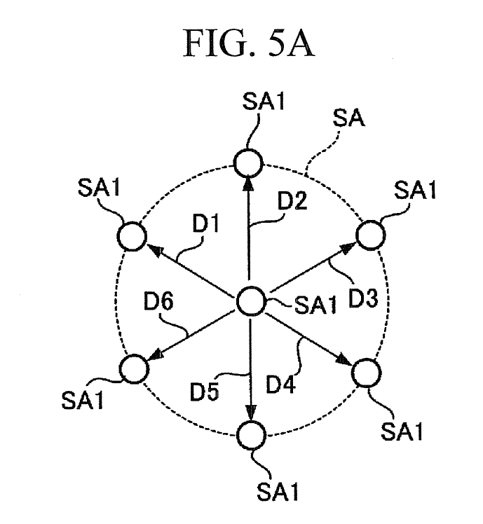

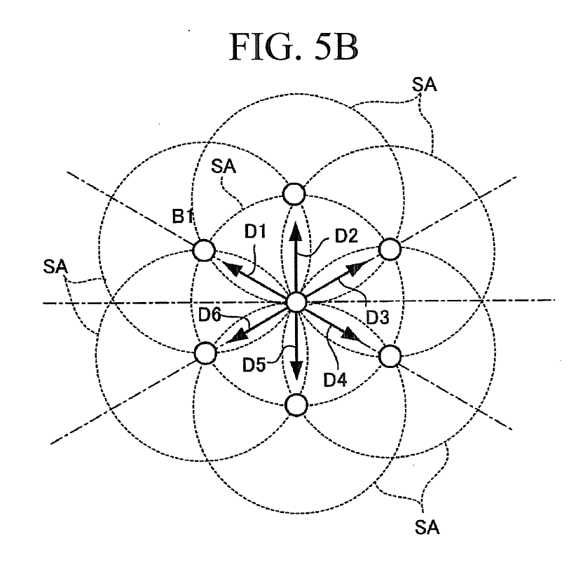

FIGS. 5A and 5B are diagrams conceptually showing the search for the cross-shape mark.

In this embodiment, the search for the cross-shape mark 111 is performed within a circular search area SA of a predetermined radius, and the search is performed by moving the search area SA so as to move the center SA1 of the search area SA from the center point of the photographed image in six directions. FIG. 5A shows the six directions D1, D2, . . . and D6 in which the center SA1 of the search area SA moves. FIG. 5B shows a state that the search area SA moves with the movement of the center SA1.

If the cross-shape mark 111 is found within the search area SA moving in that way, the movement of the search area SA stops. Next, a similar circular recognition area to the search range SA is defined about the found cross-shape mark 111 as the recognition area for the pattern recognition on a character.

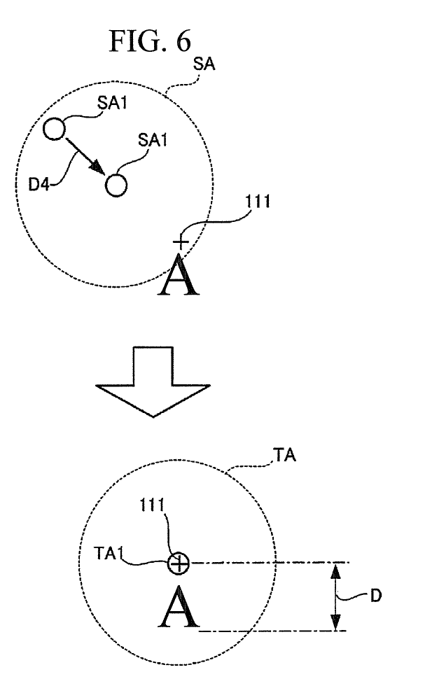

FIG. 6 is a diagram showing how a cross-shape mark is searched and how a recognition area is defined.

FIG. 6 shows how the cross-shape mark 111 is searched, and how the recognition area TA is defined.

For clear illustration, the starting point of the movement of the search area SA is illustrated at a position greatly away from a character in FIG. 6.

In the example in FIG. 6, the cross-shape mark 111 is found within the search area SA when the center SA 1 of the search area SA moves to some extent in the direction D4 toward the lower right of FIG. 6. Then, if the cross-shape mark 111 is found, the circular recognition area TA, which is similar to the form of the search area SA, is defined by handling the cross-shape mark 111 as the center TA1, as shown in FIG. 6. Here, the recognition area TA has a size sufficiently containable the known distance D between the cross-shape mark 111 and the character, as shown in FIG. 6.

The pattern recognition is performed on the character within the recognition area TA.

In this embodiment, in aid of the pattern recognition, a subject character is emphasized before the pattern recognition, as will be described below.

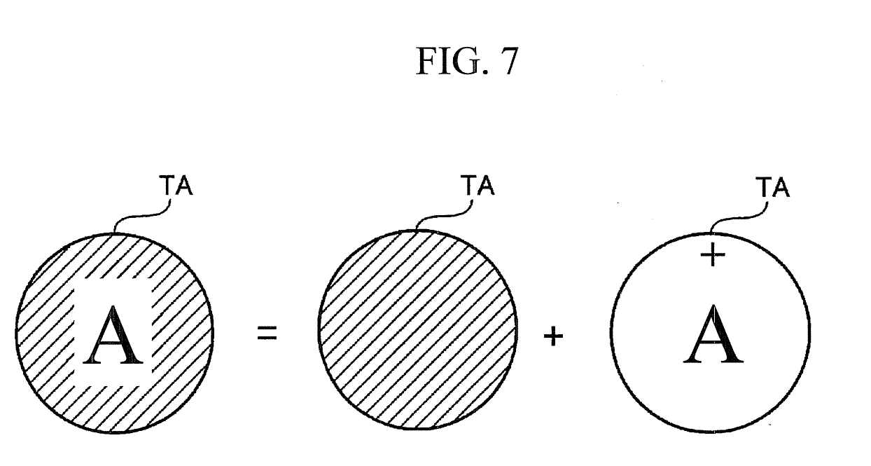

FIG. 7 is a diagram conceptually showing the character emphasis to be performed before the pattern recognition.

In the character recognition, a color difference is calculated between the cross-shape mark 111 and the surrounding background when the cross-shape mark 111 is found.

Here, in this embodiment, characters on the character sheet 110 are written in black. Then, after the recognition area TA is defined as described above, the value corresponding to the color difference is added to the pixel values of the pixels excluding pixels in a predetermined range including black pixels among multiple pixels within the recognition area. The addition of the color difference in this way can strength the color of the background within the recognition area TA and thus increase the contrast between the character in black and the background, emphasizing the character.

After emphasizing the character as described above, the pattern recognition is performed thereon within the recognition area TA, and the character within the recognition area TA is recognized. Then, the recognized character is recorded in a predetermined memory within the personal computer 200 shown in FIG. 1 and is displayed on the monitor 201 of the personal computer 200.

Next, the character input processing will be described which uses the character input system 100 described with reference to FIGS. 1 to 7.

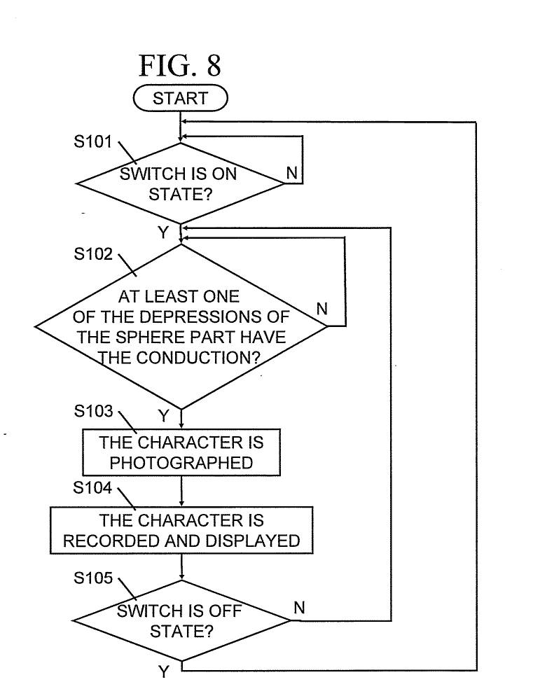

FIG. 8 is a flowchart illustrating a flow of the character input processing.

The processing illustrated on the flowchart in FIG. 8 is started upon powering on the personal computer 200 shown in FIG. 1, powering on the power switch 122 on the base 120 and powering on components of the character input apparatus 100.

In the beginning of the processing, whether the photograph switch 160 is pushed by a user to obtain the ON-state or not is determined (step S101). If the photograph switch 160 has the ON-state (Yes in step S101), the processing moves to the next step (step S102). If the photograph switch 160 is not pushed by a user and has the OFF-state (No in step S101), the character input system 10 keeps a standby state until the photograph switch 160 is turned to have the ON-state.

In step S102, whether the two conductors 142a_1 shown in FIG. 3 on at least one of the 55 depressions 142a of the sphere part 142 in FIG. 2 have the conduction or not is determined. If so (Yes in step S102), the processing moves to the next step (step S103). If not (No in step S102), the character input system 10 keeps the standby state until the conduction is confirmed.

Because reaching step S103 in the processing means that the two photographing conditions are satisfied, the character is first photographed by the digital camera 150 in step S103. Then, the photographed image obtained by the photographing is transmitted to the personal computer 200. In the personal computer 200, the character within the photographed image is recognized as described above.

If the character is recognized, the recognized character is then recorded in a predetermined memory within the personal computer 200, and the character is displayed on the monitor 201 (step S104).

If the processing in step S104 ends, whether the photograph switch 160 has the OFF-state or not is next determined (step S105). If the photograph switch 160 still has the ON-state (No in step S105), a user intends to photograph characters serially. Therefore, it is determined that the control handle 130 is being moved toward the next character by keeping the photograph switch 160 pushed. The processing returns to step S102, and the processing in step S102 to step S104 is repeated. On the other hand, if the photograph switch 160 has the OFF-state (Yes in step S105), the processing returns to step S101, and the processing in step S101 to step S104 is repeated to photograph the next character. In the character input system 10 in FIG. 1, the processing is repeated until the power switch 122 on the base 120 in FIG. 1 is turned to have the OFF-state.

The processing as described above implements the character input for each character including photographing by pushing the photograph switch 160 for each character or the serial character input including serial photographing by moving the control handle 130 by keeping the photograph switch 160 pushed.

Having illustrated the character sheet 110 in FIG. 1 on which 26 alphabets are printed as an example of the character sheet having an arrangement of a maximum of 55 characters in 5 rows by 11 columns to be placed on the sheet tray 121 on the base 120 in FIG. 1, other character sheets, which will be described below, can be placed on the sheet tray 121 for character input in the character input system 10 of this embodiment.

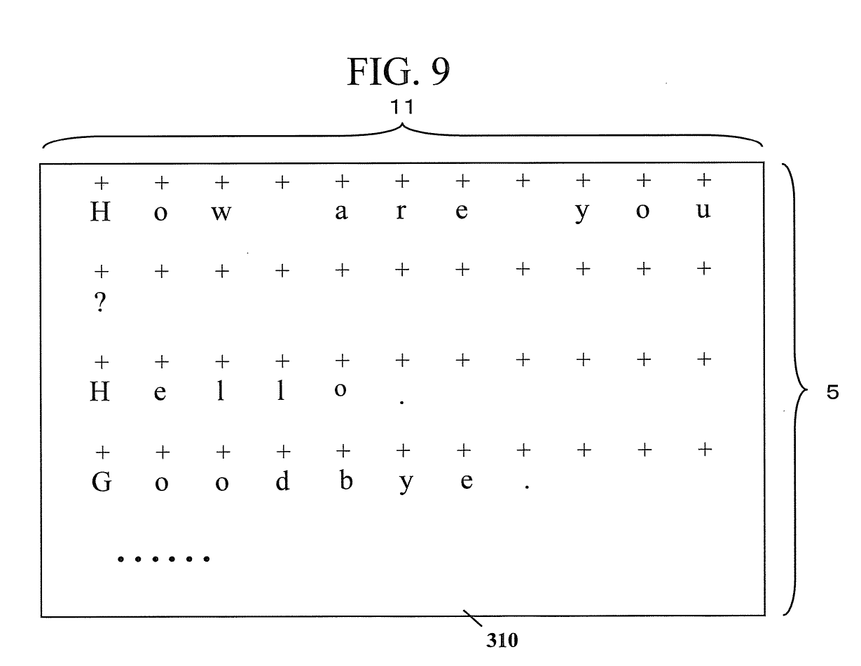

FIG. 9 is a diagram showing another character sheet example, which is different from the character sheet shown in FIG. 1.

The character sheet 110 only has an arrangement of 26 alphabets while a character sheet 310 shown in FIG. 9 has multiple kinds of phrase available for text creation printed. However, like the character sheet 110 in FIG. 1, the arrangement of characters included in a phrase is also in 5 rows by 11 columns on the character sheet 310 in FIG. 9. The character sheet 310 in FIG. 9 has a break for each phrase.

On the character sheet 310 in FIG. 9, each phrase is provided by an arrangement of characters in the row direction. In order to perform character input by using the character sheet 310, the control handle 130 in FIG. 1 is operated to illuminate the first character of a desired frame, and the photograph switch 160 is pushed under the state. With the photograph switch 160 kept pushed, the control handle 130 is moved in the direction corresponding to the row direction of the phrase. Because the characters of a phrase are serially photographed in the row direction, the character input is performed efficiently.

Having illustrated up to this point that the character sheet on which characters are printed, a character sheet having hand-written characters may be placed on the sheet tray 121 to perform character input in the character input system 10 of this embodiment.

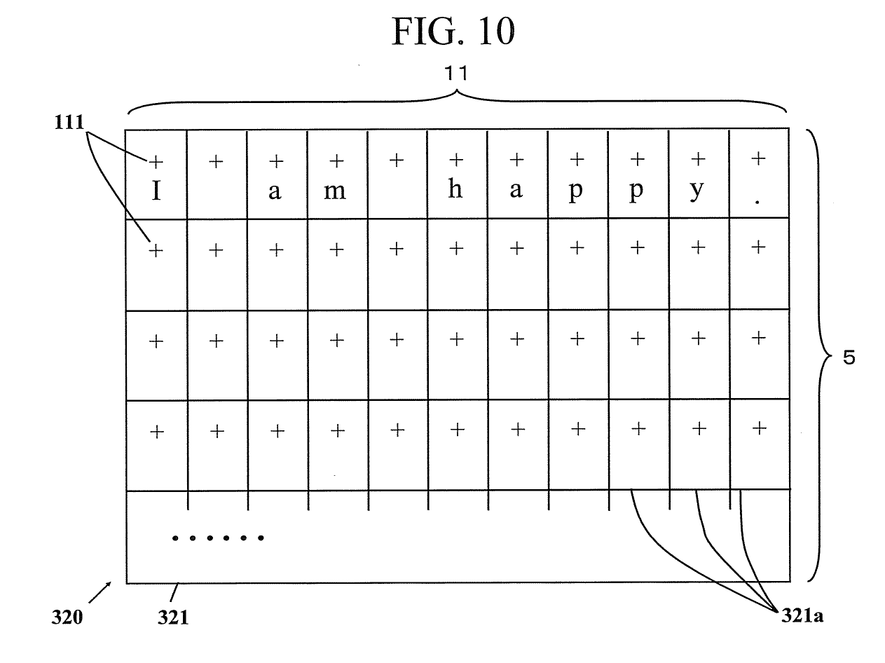

FIG. 10 is a diagram showing an example of the character sheet having hand-written characters.

FIG. 10 shows a character sheet 320 on which a desired phrase is constructed by hand-written characters. However, also on the character sheet 320, the arrangement of characters must be an arrangement of 5 rows by 11 columns, like the character sheets 110 and 310 by printing, corresponding to the 55 subject positions on the sheet tray 121 on the base 120 in FIG. 1. For that reason, in order to create the character sheet 320 by hand-writing, a manuscript paper 321 having 55 fields 321a arranged in 5 rows by 11 columns is prepared in this embodiment.

On the manuscript paper 321, a cross-shape mark 111 to be used for the character recognition is provided at an upper predetermined position in each of the fields 321a. In order to write a desired phrase in the manuscript paper 321, a user may write characters of the phrase under the cross-shape marks 111 within the fields 321a.

The character input by using the character sheet 320 by hand-writing can also be performed efficiently by serial photographing along the arrangement of characters of a phrase, like the character input by using the character sheet 310 in FIG. 9.

As described above, the character input system 10 of this embodiment allows easy character input by operating the control handle 130 in FIG. 1 by one hand and photographing a character on the character sheet. Because the attitudes that the control handle 130 can take are limited to multiple attitudes corresponding to the arrangement positions of characters on the character sheet on the one-to-one basis, incorrect input of characters due to a problem in photographing such as photographing parts excluding characters or photographing a character partially can be effectively suppressed without particular user awareness. Because the character input system 10 of this embodiment allows character input by easy operations by one hand, elderly or handicapped users, for example, can input characters easily.

A specific embodiment of the second basic form of the character input system will be described next.

The embodiment of the second basic form of the character input system is different from the embodiment of the first basic form of the character input system in that character input is performed without using a character sheet as described above. The difference will be focused in the following description on the embodiment of the second basic form of the character input system.

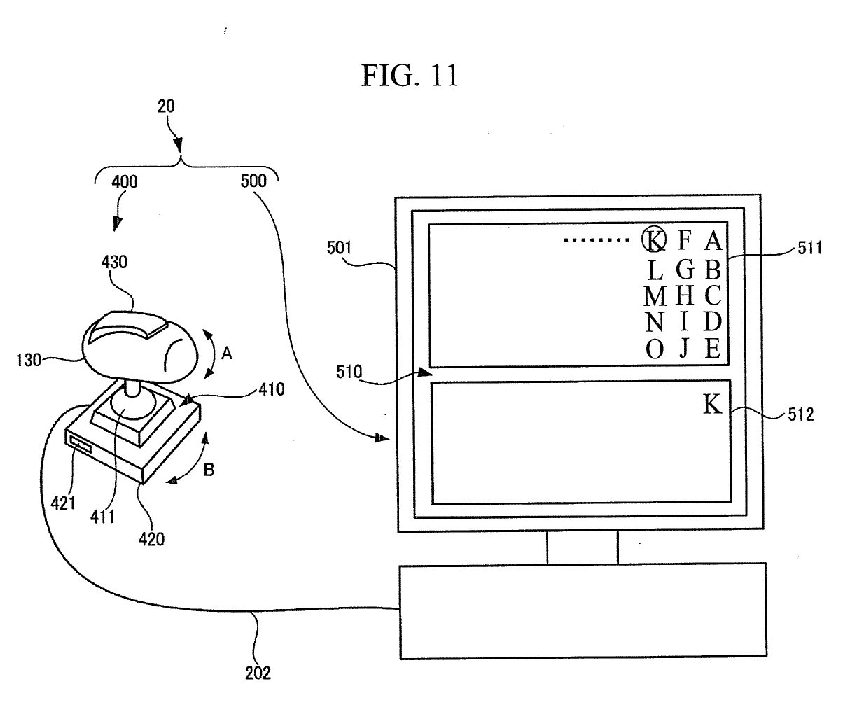

FIG. 11 is a diagram showing the specific embodiment of the second basic form of the character input system.

The same reference numerals as those in FIG. 1 will be given to similar components in FIG. 11 to the components shown in FIG. 1, and the repetitive description thereon will be omitted hereinafter.

A character input system 20 shown in FIG. 11 includes a character input apparatus 400 having the control handle 130 to be moved by a user to select a desired character from the multiple characters displayed on a monitor 501 of a personal computer 500. In the personal computer 500, the character corresponding to the attitude of the control handle 130 is recognized. Also in this embodiment, the personal computer 500 functions as the personal computer to which a character is inputted by the character input system 20. The character input apparatus 400 corresponds to an example of the character input apparatus in the second basic form of the character input system, and the personal computer 500 corresponds to an example of the character recognizing apparatus in the basic form.

The character input system 20 also includes a base 420 on which the control handle 130 is supported by a supporting mechanism 410 having an equivalent structure to that of the supporting mechanism 140 shown in FIG. 2. Like the base 120 of the embodiment of the first basic form of the character input system shown in FIG. 1, the base 420 has a power switch 421 for powering on components of the character input apparatus 400 and also acts as an interface for exchanging information with the personal computer 500. However, because no sheet trays such as the one on the base 120 in FIG. 1 are provided, the base 420 has a smaller size than that of the base 120 in FIG. 1. The base 410 corresponds to an example of the base in the second basic form of the character input system.

In this embodiment, because the character input is performed by character selection on the monitor 501 instead of the photographing in the embodiment of the first basic form of the character input system, a select switch 430 to be used for the character selection is only mounted on the control handle 130, and the control handle 130 does not have a digital camera and a light that illuminates a subject position like those in the embodiment of the first basic form of the character input system.

In this embodiment, if the personal computer 500 is powered on and the power switch 421 on the base 420 is turned to have the ON-state to power on components excluding the personal computer 500, the monitor 501 displays a control screen 510 for performing character input.

The control screen 510 includes a first display section 511 and a second display section 512. The first display section 511 displays a list of a maximum of 55 characters in an arrangement of 5 rows by 11 columns, which are inputted in advance to the personal computer 500 as a parent population under selection and are stored in a predetermined memory. The second display section 512 displays characters selected and arranged sequentially as text. In the example in FIG. 11, alphabets are displayed on the first display section 511 in an arrangement of 5 rows by 11 columns as the parent population under selection.

In this embodiment, 55 depressions (refer to FIG. 2) on a sphere part 411 of the supporting mechanism 410 correspond to 55 layout positions in the arrangement of 5 rows by 11 columns on the first display section 511 on the one-to-one basis on the program. Thus, the correspondence is established between 55 attitudes of the control handle 130 supported by the supporting mechanism 410 and the 55 layout positions on the first display section 511 on the one-to-one basis. A predetermined memory in the personal computer 500 stores a table having correspondence between the 55 attitudes of the control handle 130 and the 55 layout positions on the first display section 511. Here, each of the layout positions on the first display section 511 has a character which is input in advance to the personal computer 500. In other words, the table having correspondence between the attitudes of the control handle 130 and the layout positions on the first display section 511 indirectly has correspondence between the attitudes of the control handle 130 and the characters which are input in advance to the personal computer 500. The table corresponds to an example of the table in the second basic form of the character input system.

If a user moves the control handle 130 and causes the control handle 130 to have one attitude, the two conductors (refer to FIG. 3) on the depression according to the attitude are brought into conduction. Then, attitude information describing which depression of the 55 depressions has two conductors in conduction, that is, which attitude of the 55 attitudes the control handle 130 is taking is transmitted from the base 420 to the personal computer 500.

The personal computer 500 in response to the reception of the attitude information recognizes the layout position corresponding to the attitude indicated by the attitude information on the table. The monitor 501 displays the character at the layout position within a circle as shown in FIG. 11. Thus, a user can visually check which character of the characters displayed on the first display section 511 is currently being selected.

Next, a user may move the control handle 130 until a desired character is placed within a circle by checking the display of the characters on the first display section 511 and push the select switch 430 with the desired character within a circle. Then, switch operation information indicating that the select switch 430 has been pushed is transmitted from the base 420 to the personal computer 500.

The personal computer 500 in response to the reception of the switch operation information recognizes the character at the layout position corresponding to the attitude indicated by the attitude information at that time. The recognized character is recorded in a predetermined memory within the personal computer 500. The monitor 501 displays the character at the layout position on the second display section 512 as shown in FIG. 11.

In this embodiment, a character is only placed within a circle if the select switch 430 is not pushed. If the select switch 430 is pushed to select a character, the inside of the circle enclosing the character is colored on the display. Thus, a user can check that the character desired by himself/herself is recognized.

Here, each of the 55 depressions corresponds to an example of the sensor in the second basic form of the character input system. The select switch 430 corresponds to an example of the switch in the second basic form. The combination of the control handle 130, supporting mechanism 410 and select switch 430 corresponds to an example of the controller in the second basic form.

Even in the character input system 20 as the embodiment of the second basic form of the character input system as described above, a user can perform a character input operation by one hand, and the control handle 130 can take the limited attitudes, which can effectively suppress incorrect input of characters. Therefore, like the embodiment of the first basic form of the character input system, the character input system 20 as the embodiment of the first basic form of the character input system allows elderly or handicapped users, for example, to input characters easily.

Having illustrated above the character input system in which the control handle can take 55 attitudes and the maximum number of characters which can be inputted is 55 in connection with that as embodiments of the character input system according to the first and second basic forms, the present invention is not limited thereto. In a character input system according to the basic forms, the control handle may take the number of attitudes excluding 55, and the maximum number of characters which can be inputted may be any number excluding 55.

Having illustrated above the character input system in which the arrangement of characters is 5 rows by 11 columns, and, in accordance with the arrangement of the characters, the control handle can rotate in five steps in the direction corresponding to the row direction of the arrangement and can rotate in 11 steps in the column direction as embodiments of the characteristic input system according to the first and second basic forms, the present invention is not limited thereto. In the character input system according to the basic forms, the arrangement of characters may be any arrangement excluding the arrangement of 5 rows by 11 columns, and the control handle may rotate in accordance with the arrangement.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A system for character recognition from a sheet bearing a plurality of characters, comprising:
a base for supporting the sheet;
an image input device for taking an image of each of the characters on the sheet;
a handle for supporting and manipulating the image input device;
an axis fixed to the handle at one end thereof;
a sphere part, fixed to the axis at the other end of the axis;
a receiving part fixed to the base and having a hollow for accommodating the sphere part, one of the sphere part and the hollow having a plurality of depressions and the other having a projection for fitting into one of the depressions, whereby when a view angle of the image input device is changed to point a location of each of characters on the sheet by manipulation of the handle, the image input device is rotated about the axis; and
a character recognizing unit for recognizing the character on the image taken by the image input device.

2. The system of claim 1, wherein when the view angle of the image input device is changed, the projection travels along with the depression to cause the axis to rotate so as to correct the rotation angle of the image input device with respect to each of the characters.

3. The system of claim 1, wherein the characters are arranged in a matrix in a plane.

4. The system of claim 1, wherein the image input device further comprises a switch for enabling the image input device to take an image of each of the characters.

5. The system of claim 4, wherein the image input device further comprises a light for illuminating each of the characters.

6. The system of claim 5, wherein colors of illumination by the light differ on the basis of whether the switch is manipulated or not.

7. The system of claim 1, wherein the sheet comprises a plurality of marks corresponding to each of the arrangement of characters, the mark being a reference for a position of each of the characters.
